(19) United States
(12) Patent Application Publication
(10) Pub. No.: US 2026/0225666 A1
(43) Pub. Date: Aug. 6, 2026

(54) REAR STRUCTURE OF A PICKUP TRACK

(71) Applicant: TOYOTA JIDOSHA KABUSHIKI KAISHA, Aichi-ken (JP)

(72) Inventors: Hideki KANKI, Toyota-shi (JP); Katsutaka MOTOCHI, Okazaki-shi (JP)

(21) Appl. No.: 19/415,780

(22) Filed: Dec. 11, 2025

(30) Foreign Application Priority Data
Jan. 31, 2025 (JP) 2025-015627

(51) Int. Cl. B62D 25/20; B62D 25/08

(52) U.S. Cl. CPC B62D 25/2027; B62D 25/088

(57) ABSTRACT

A rear structure of a pickup track, the rear structure comprises a rear wheel house bulging upward from a deck of a cargo bed at both ends of the cargo bed in a vehicle width direction, a rear suspension having a rear absorber and supporting a vehicle body, an absorber R/F welded to the rear wheel house and to which the rear absorber is attached and a strainer welded to the rear wheel house and the deck and connecting the rear wheel house and the deck.

### CROSS REFERENCE TO RELATED APPLICATION

This application claims priority to Japanese Patent Application No. 2025-015627 filed on Jan. 31, 2025, which is incorporated herein by reference in its entirety including the specification, claims, drawings, and abstract.

### TECHNICAL FIELD

This specification discloses a rear structure of a pickup track.

### BACKGROUND

In general, a vehicle body is supported by a suspension. The suspension has an absorber for damping vibration. An upper end of an absorber of the rear suspension (hereinafter referred to as a “rear absorber”) is connected to a wheel arch of the rear wheel.

Naturally, the vibration from the road surface is transmitted to the vehicle body via the rear suspension. Here, the rear absorber is inclined such that, as it extends upward, it advances inward in the vehicle width direction. Therefore, when a load is input from the rear absorber to the rear wheel house, there is a possibility that the rear wheel house will deform so as to tilt inward in the vehicle width direction.

Therefore, conventionally, a cross member has been disposed between a pair of left and right rear wheel houses. By arranging the cross member between the pair of left and right rear wheel houses, the rigidity of the vehicle body around the rear wheel house is improved, and deformation of the rear wheel house can be effectively prevented.

However, such the cross member arrangement structure cannot be applied to a pickup track. That is, as shown in PATENT LITERATURE 1, the pickup truck has a substantially box-shaped cargo bed at the rear of the vehicle. In the case of the pickup truck, the deck of the cargo bed has a substantially flat shape with little unevenness in order to sufficiently secure the capacity of the cargo bed. In other words, in the case of the pickup truck, the cross member cannot be disposed between the pair of left and right rear wheel houses. As a result, in the conventional pickup truck, deformation of the rear wheel house cannot be sufficiently prevented.

Therefore, this specification provides a rear structure of a pickup truck capable of suppressing deformation of a rear wheel house.

### CITATION LIST

PATENT LITERATURE 1: JP 2013-067325 A

### SUMMARY

A rear structure of a pickup track disclosed in this specification, the rear structure comprises: a rear wheel house bulging upward from a deck of a cargo bed at both ends of the cargo bed in a vehicle width direction; a rear suspension having a rear absorber and supporting a vehicle body; an absorber R/F welded to the rear wheel house and to which the rear absorber is attached; and a strainer welded to the rear wheel house and the deck and connecting the rear wheel house and the deck.

In this case, the rear structure may further comprises a floor side member extending in a vehicle front-rear direction and passing through a lower side of the strainer, wherein the strainer may be further welded to the floor side member.

The absorber R/F may have a substantially L-shaped cross section extending from a circumferential surface of the rear wheel house to a side surface of the rear wheel house and conforming to a shape of the rear wheel house, and the strainer may have a substantially L-shaped cross section in which a portion along the side surface of the rear wheel house and a portion along the deck are connected to each other.

In this case, the absorber R/F may have one or more beads extending in a direction intersecting the vehicle front-rear direction, and the strainer may have one or more beads extending in a direction intersecting the vehicle front-rear direction.

The absorber R/F may have a first bead protruding toward a vehicle inner side, and a pair of second beads protruding toward a vehicle outer side on both sides in the vehicle front-rear direction of the first bead, the strainer may have a third bead protruding toward the vehicle outer side, and a pair of fourth beads protruding toward the vehicle inner side on both sides of the third bead in the vehicle front-rear direction, and a fastening portion for attaching the rear absorber may be disposed in each of the pair of second beads.

According to the technology disclosed herein, the rear wheel house is reinforced with an absorber R/F and a strainer. Therefore, deformation of the rear wheel house is effectively prevented without providing a cross member between the pair of rear wheel houses.

### BRIEF DESCRIPTION OF DRAWINGS

Embodiment(s) of the present disclosure will be described based on the following figures, wherein:

FIG. 1 is a perspective view of the rear portion of a vehicle;

FIG. 2 is a diagram in which only the absorber R/F and a strainer are extracted;

FIG. 3 is a cross-sectional view of a periphery of the rear wheel house cut in the vehicle width direction; and

FIG. 4 is a view showing an example of a conventional vehicle rear structure.

### DESCRIPTION OF EMBODIMENTS

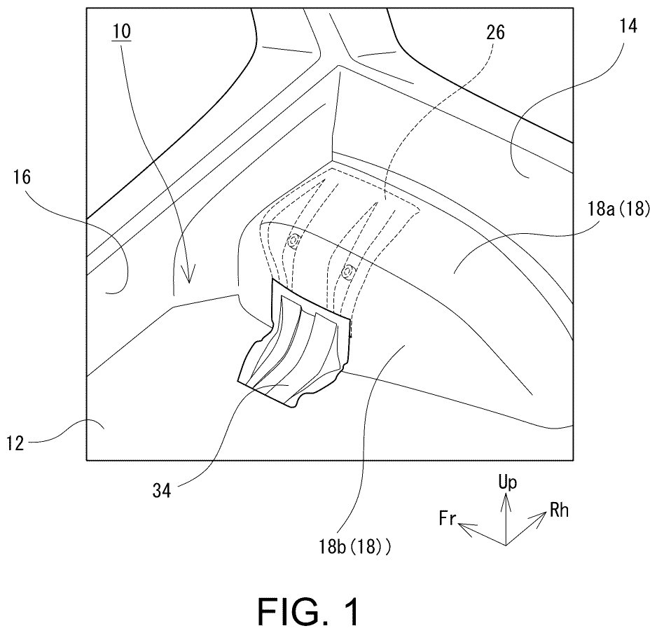

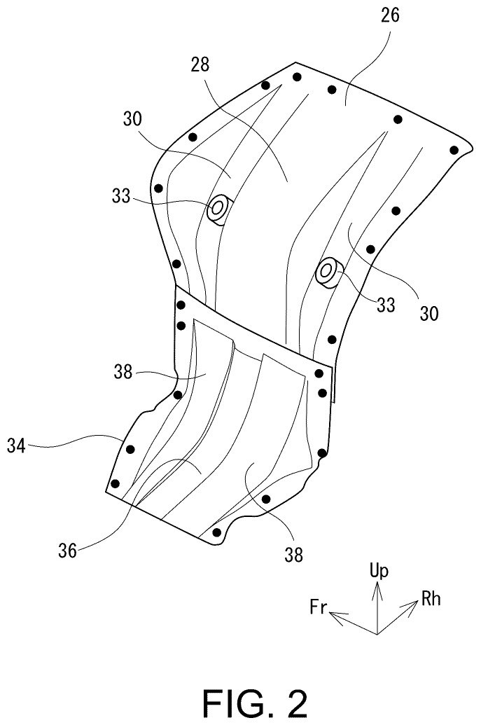

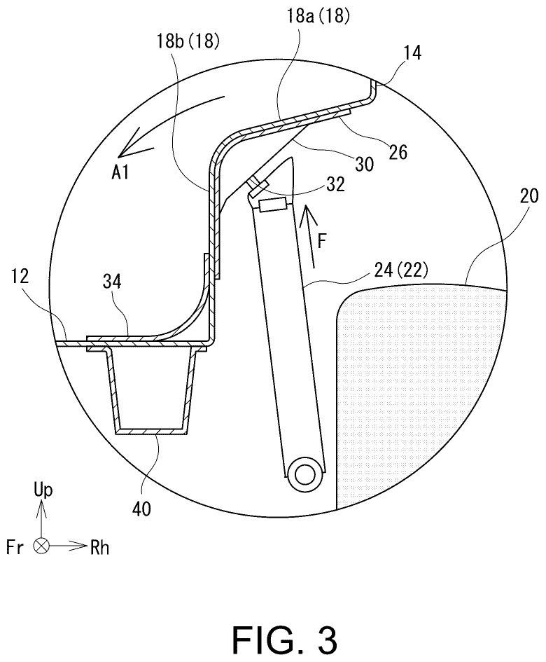

Hereinafter, a rear structure of a vehicle will be described with reference to the drawings. FIG. 1 is a perspective view of a rear portion of a vehicle. The vehicle is a pickup truck having a cargo bed 10 behind a cabin (not shown). FIG. 1 shows the vicinity of the front corner of the cargo bed 10 of the pickup truck. FIG. 2 is a view in which only an absorber reinforcement 26 (hereinafter abbreviated as “absorber R/F 26”) and a strainer 34 are extracted. FIG. 3 is a cross-sectional view of a periphery of a rear wheel house 18 cut in a vehicle width direction.

The cargo bed 10 has a substantially box shape. That is, the cargo bed 10 includes a front wall 16 separating the cabin and the cargo bed 10, a pair of side walls 14, an openable and closable tailgate (not shown), and a deck 12 constituting a floor surface of the cargo bed 10. Rear wheel houses 18 are disposed at both ends of the cargo bed 10 in the vehicle width direction.

The rear wheel house 18 protrudes upward from the deck 12 along the circumferential surface and the inner side surface of the rear wheel 20. Therefore, the rear wheel house 18 has a circumferential surface 18a along the circumferential surface of the rear wheel 20 and an inner side surface 18b along the inner side surface of the rear wheel 20. In order to simplify the description, in FIG. 3, the rear wheel house 18, the side wall 14, and the deck 12 are all shown as one connected element. However, in practice, these elements may be constructed by joining a plurality of press parts.

A rear wheel 20 is disposed in a lower space of the rear wheel house 18. A rear suspension 22 is attached to the rear wheel 20. The rear suspension 22 supports the vehicle body. The rear suspension 22 alleviates the impact from the road surface. The rear suspension 22 and the rear absorber 24 are damping devices for damping vibration of a suspension spring (not shown). The upper end of the rear absorber 24 is fastened to the rear wheel house 18 via a fastening member. The load transmitted from the road surface to the rear absorber 24 via the rear wheel 20 is input to the rear wheel house 18.

An absorber R/F 26 is welded to a portion of the rear wheel house 18 to which the rear absorber 24 is fastened. The absorber R/F 26 is a panel member that reinforces the fastening portion 32 (see FIG. 3) of the rear absorber 24. As shown in FIG. 1, the absorber R/F 26 is curved in a substantially L-shape along the circumferential surface 18a and the inner side surface 18b of the rear wheel house 18. As shown in FIG. 2, the absorber R/F 26 has a first bead 28 and a second bead 30 extending in the vehicle width direction. The first bead 28 is a bead that protrudes toward the vehicle inner side. A total of two second beads 30 are provided on both sides of the first bead 28 in the front-rear direction. The second bead 30 is a bead that protrudes toward the vehicle outer side. A fastening hole (not shown) for fastening the rear absorber 24 is formed in the second bead 30. A weld nut 33 (see FIG. 2) is fixedly disposed on the upper surface (i.e., the surface facing the inside of the vehicle) of the second bead 30 so as to be concentric with the fastening hole. Since the second bead 30 protrudes toward the vehicle outer side, a slight space is formed between the second bead 30 and the rear wheel house 18. Therefore, since the weld nut 33 is located inside this space, interference between the weld nut 33 and the rear wheel house 18 is prevented.

A strainer 34 is also welded to the rear wheel house 18. The strainer 34 is a panel member that reinforces the periphery of the boundary between the rear wheel house 18 and the deck 12. The strainer 34 is disposed on the cargo bed 10. The strainer 34 is curved in a substantially L-shape along the inner side surface 18b of the rear wheel house 18 and the deck 12.

The strainer 34 has a third bead 36 and a fourth bead 38. The third bead 36 is a bead that protrudes toward the vehicle outer side. A total of two fourth beads 38 are provided on both sides of the third bead 36 in the front-rear direction. The fourth bead 38 is a bead that protrudes toward the vehicle inner side. It should be noted that a position in the front-rear direction of the third bead, which protrudes toward the outside of the vehicle, is substantially the same as a position in the front-rear direction of the first bead, which protrudes toward the inside of the vehicle. And a position in the front-rear direction of the fourth bead, which protrudes toward the outside of the vehicle, is substantially the same as a position in the front-rear direction of the second bead, which protrudes toward the inside of the vehicle.

A pair of floor side members 40 are fixed to the underside of the deck 12. The floor side member 40 is a frame member extending in the vehicle front-rear direction. In the present example, as shown in FIG. 3, the floor side member 40 has a substantially hat-shaped cross section that opens upward. The flange portion of the floor side member 40 is welded to the underside of the deck 12. In this example, the deck 12 is disposed at a position that passes below the strainer 34. Note that black circles in FIG. 2 indicate an example of a welded portion.

Here, the upper end of the strainer 34 is located above the lower end of the absorber R/F 26. Therefore, the upper end portion of the strainer 34, the rear wheel house 18, and the lower end portion of the absorber R/F 26 are stacked in the thickness direction. In this example, the upper end portion of the strainer 34, the rear wheel house 18, and the lower end portion of the absorber R/F 26 are welded to each other.

The inner edge of the strainer 34 in the vehicle width direction is located directly above the inner end portion of the floor side member 40 in the vehicle width direction. In this example, the inner end portion of the strainer 34 in the vehicle width direction, the deck 12, and the inner end portion of the floor side member 40 in the vehicle width direction are welded to each other.

Next, the reason why such a structure is formed will be described. As shown in FIG. 3, the rear absorber 24 is attached to the rear wheel house 18 in a posture slightly inclined inward in the vehicle width direction. Therefore, the load F input to the rear absorber 24 from the road surface is transmitted to the rear wheel house 18 as an obliquely upward load. When such an obliquely upward load F is input to the rear wheel house 18, the rear wheel house 18 may be inclined in the vehicle width direction inward direction, that is, in the direction of the arrow A1 in FIG. 3.

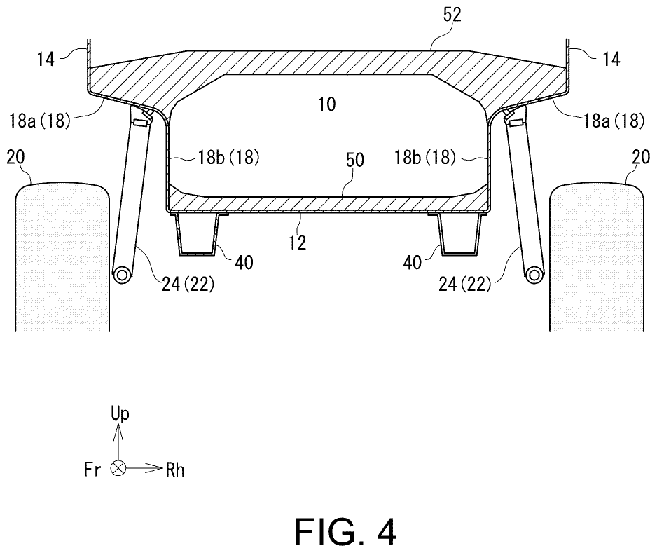

Here, in order to prevent such inclination of the rear wheel house 18, conventionally, as shown in FIG. 4, it has been proposed to dispose the cross member 50 above the deck 12 and between the pair of rear wheel houses 18. In addition, when the vehicle is not a pickup truck, it is proposed to dispose an upper cross member 52 that connects upper portions of the pair of rear wheel houses 18. In such a configuration, the two cross members 50 and 52 function as protruding bars, and can effectively prevent the rear wheel house 18 from falling inward.

However, the configuration shown in FIG. 4 is effective for ordinary passenger cars, but is difficult to apply to pickup trucks. That is, since the cargo bed 10 of the pickup truck is an open type, the pickup truck cannot be provided with the upper cross member 52. In addition, when the cross member 50 is provided on the upper surface of the deck 12, the capacity of the cargo bed 10 is reduced. In addition, in the case where the cross member 50 is provided on the upper surface of the deck 12, the deck 12 becomes a non-flat surface, and thus the convenience of the cargo bed 10 is lowered. That is, in the case of the pickup truck, it is difficult to dispose the cross member between the pair of rear wheel houses 18.

Therefore, in the present embodiment, the absorber R/F 26 and the strainer 34 are welded to the rear wheel house 18. As described above, the absorber R/F 26 reinforces the rear wheel house 18 along the surface of the rear wheel house 18. The strainer 34 connects the rear wheel house 18 and the deck 12. By providing the absorber R/F 26 and the strainer 34, the rear wheel house 18 is effectively prevented from falling inward in the vehicle width direction. Accordingly, since it is not necessary to dispose the cross members 50 and 52 between the pair of rear wheel houses 18, it is possible to obtain the cargo bed 10 that is large and easy to use.

Each of the absorber R/F 26 and the strainer 34 has beads 28, 30, 36, and 38 extending in a direction intersecting the front-rear direction. By providing the beads 28, 30, 36, and 38, bending along the front-rear direction is less likely to occur in the absorber R/F 26 and the strainer 34. Further, since the absorber R/F 26 and the strainer 34 are less likely to break, the fall of the rear wheel house 18 is effectively suppressed.

Further, in the present embodiment, the floor side member 40 is disposed below the strainer 34. With such a configuration, the rigidity of the strainer 34 and the deck 12 is further improved, and the tilting of the rear wheel house 18 is more effectively prevented.

Note that all of the configurations described above are examples, and other configurations may be appropriately changed as long as the configuration described in claim 1 is provided. For example, the shape and the number of beads formed in the absorber R/F 26 and the strainer 34 may be changed as appropriate.

### REFERENCE SIGNS LIST

10 cargo bed, 12 deck, 14 side wall, 16 front wall, 18 rear wheel house, 18a circumferential surface, 18b inner side surface, 20 rear wheel, 22 rear suspension, 24 rear absorber, 26 absorber R/F, 28 first bead, 30 second bead, 32 fastening portion, 33 weld nut, 34 strainer, 36 third bead, 38 fourth bead, 40 floor side member, 50 cross member, 52 upper cross member.

1. A rear structure of a pickup track, the rear structure comprising:
a rear wheel house bulging upward from a deck of a cargo bed at both ends of the cargo bed in a vehicle width direction;
a rear suspension having a rear absorber and supporting a vehicle body;
an absorber R/F welded to the rear wheel house and to which the rear absorber is attached; and
a strainer welded to the rear wheel house and the deck and connecting the rear wheel house and the deck.

2. The rear structure of the pickup track according to claim 1, further comprising:
a floor side member extending in a vehicle front-rear direction and passing through a lower side of the strainer, wherein
the strainer is further welded to the floor side member.

3. The rear structure of the pickup track according to claim 1, wherein
the absorber R/F has a substantially L-shaped cross section extending from a circumferential surface of the rear wheel house to a side surface of the rear wheel house and conforming to a shape of the rear wheel house, and
the strainer has a substantially L-shaped cross section in which a portion along the side surface of the rear wheel house and a portion along the deck are connected to each other.

4. The rear structure of the pickup track according to claim 3, wherein
the absorber R/F has one or more beads extending in a direction intersecting the vehicle front-rear direction, and
the strainer has one or more beads extending in a direction intersecting the vehicle front-rear direction.

5. The rear structure of the pickup track according to claim 4, wherein
the absorber R/F has a first bead protruding toward a vehicle inner side, and a pair of second beads protruding toward a vehicle outer side on both sides in the vehicle front-rear direction of the first bead,
the strainer has a third bead protruding toward the vehicle outer side, and a pair of fourth beads protruding toward the vehicle inner side on both sides of the third bead in the vehicle front-rear direction, and
a fastening portion for attaching the rear absorber is disposed in each of the pair of second beads.
